(19) United States
(12) Patent Application Publication
(10) Pub. No.: US 2026/0285006 A1
(43) Pub. Date: Sep. 24, 2026

(54) Low Friction Magnetic Liner

(71) Applicant: Buffalo Wire Works Company, Inc., Buffalo, NY (US)

(72) Inventors: Matthew Henderson, East Aurora, NY (US); Dominic Nasso, East Amherst, NY (US)

(73) Assignee: Buffalo Wire Works Company, Inc., Buffalo, NY (US)

(21) Appl. No.: 19/086,626

(22) Filed: Mar. 21, 2025

(51) Int. Cl. B32B 7/12; B32B 27/40; B32B 38/00; B65G 21/20

(52) U.S. Cl. CPC B32B 7/12; B32B 27/40; B32B 38/0012; B65G 21/2045; B32B 2038/0016; B32B 2250/02; B32B 2305/34; B32B 2307/208; B32B 2307/746; B65G 2207/48

(57) ABSTRACT

An improved liner for a conveyor assembly includes a first, relatively higher friction layer, a second, relatively lower friction layer fixed to the first layer, and magnets configured for securing the liner to surface of the conveyor assembly. A method of manufacturing the liner includes providing a first layer and affixing a second layer with embedded magnets to the first layer.

### FIELD OF THE TECHNOLOGY

The subject disclosure relates to mining and quarry equipment, and more particularly to a liner for such equipment that has a low friction surface.

### BACKGROUND OF TECHNOLOGY

The aggregate and mining industries utilize many types of machines to extract, convey, and sort raw material. For example, conveyor systems are common for moving materials from location to location. A conveyor system often incorporates a moving belt, e.g., a conveyor belt, along which the raw material is moved. Moreover, chutes and/or other conduits often are provided to move raw material to and/or receive raw material from the conveyor belt. Some conventional material handling systems can be prone to fugitive materials, e.g., particulates that inadvertently escape the conveyor belt and/or chute. These fugitive materials can be airborne particles that settle as dust or other debris, and which can be deleterious to components of the system, surrounding equipment, and/or the like.

To reduce fugitive material, conveyor systems often incorporate skirting. For example, skirting can include one or more of side walls, top walls, and/or other stationary walls. Skirting limits fugitive materials by retaining material on the belt, reducing and/or preventing raw material, including dust, from falling from the conveyor belt, and/or the like. In some examples, skirting comprises sidewalls that are configured to contact the conveyor belt, e.g., to create a seal between the sidewalls and the conveyor belt.

Conventional systems such as those just described can also, or alternatively, be prone to wear at raw material transfer locations. For example, a chute configured to receive raw material from a conveyor belt may be quicker to wear due to the continuous impact of raw material. This wear may be particularly exacerbated for certain types of raw materials and/or at surfaces at which the raw material impacts at relatively higher speeds (such as when the material falls a distance from a conveyor belt). Skirting may also be useful proximate these areas at which raw material enters the conveyor system and/or on surfaces impacted by raw material leaving the conveyor belt.

Skirting is generally stationary, e.g., with the conveyor belt moving relative to the skirting. Accordingly, skirting may become damaged or otherwise compromised over time, e.g., as raw material abrades or otherwise damages exposed surfaces. Moreover, conventionally, raw material can adhere or otherwise stick to exposed surfaces of the skirting, causing unwanted blockages, build up, and/or the like. Moreover, such build-up can be resource intensive to remove.

Accordingly, there is a need in the art for improvements in mining and quarry equipment, such as conveyors. For example, there is a need in the art for improved skirting and safety equipment. There is also a need in the art for improved devices that minimize build up and/or are easier to maintain.

### SUMMARY OF THE TECHNOLOGY

The subject technology relates to liners for use with mining and/or quarry equipment, including but not limited to conveyor systems. In examples, aspects of this disclosure relate to composite magnetic panels for placement on existing surfaces, such as surfaces of skirting disposed proximate a conveyor belt. In some examples, liners according to this disclosure may include a first layer in which magnets, such as rare earth magnets, are disposed and a second layer formed on the first layer and having a low coefficient of friction and/or high lubricity. In examples, the first layer faces an exposed surface of the skirting and/or the second layer is positioned to contact the raw material carried on a conveyor.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a schematic representation of a material handling system, in accordance with aspects of this disclosure.

FIG. 2A is a perspective view of a liner for use in a system such as the material handling system of FIG. 1, in accordance with aspects of this disclosure.

FIG. 2B is an example cross-sectional view of the liner of FIG. 2A, taken along the section line 2B-2B in FIG. 2A, in accordance with aspects of this disclosure.

FIG. 2C is another example cross-sectional view of the liner of FIG. 2A, taken along the section line 2B-2B in FIG. 2A, in accordance with aspects of this disclosure.

FIGS. 3 and 4 are perspective views of alternative liners for use in material handling systems, in accordance with aspects of this disclosure.

FIGS. 5 and 6 are perspective views of still further alternative liners for use in material handling systems, in accordance with aspects of this disclosure.

FIG. 7A is a perspective view of an alternative liner design, in accordance with aspects of this disclosure.

FIG. 7B is a cross-sectional view of the liner of FIG. 7A, taken along the section line 7B-7B in FIG. 7A, in accordance with aspects of this disclosure.

FIG. 8A is a perspective view of an alternative liner design, in accordance with aspects of this disclosure.

FIG. 8B is a cross-sectional view of the liner of FIG. 8A, taken along the section line 8B-8B in FIG. 8A, in accordance with aspects of this disclosure.

FIG. 9 is a flow chart demonstrating a first method of manufacturing a reduced friction liner, in accordance with aspects of this disclosure.

FIG. 10 is a flow chart demonstrating a second method of manufacturing a reduced friction liner, in accordance with aspects of this disclosure.

### DETAILED DESCRIPTION

As noted above, conventional conveyor and mining machinery can be adversely affected by caking, sticking and/or other accumulation of raw material. Some conventional attempts to alleviate these problems include providing low-friction liners at strategic positions where this accumulation may be likely to happen. Conventionally, these liners include a plurality of holes forming a hole pattern that matches a corresponding hole pattern on the equipment surface to which the liner is to be attached. In these conventional examples, the liner is bolted to the equipment using these holes. While the liner may be successful at reducing accumulation of material, the fasteners themselves are still susceptible to material build up. Moreover, manufacturing, use and/or maintenance associated with these conventional liners can be cumbersome. For example, during manufacture, the formation of the holes requires a separate machining process. In some instances, the holes may be drilled on site to ensure that they properly align. Time also is required to apply and tighten the fasteners during installation as well as to regularly check and re-tighten and/or replace the fasteners.

The subject technology overcomes many of the prior art problems associated with skirting used in conveyor and similar machinery. In brief summary, the subject technology provides a multi-material, magnetic liner for use with skirting on a conveyor or other mining or quarry machinery. In examples, the liner may be a canoe liner having embedded magnets proximate a first side of a first layer and a second, low-friction surface on a second layer, disposed for contact by raw material. The magnets in the first layer retain the liner on the skirting surface and the low-friction surface resists sticking or other accumulation of material. When compared to conventional liners discussed above, the liners disclosed herein can be magnetically attached to equipment, obviating the need for fasteners, holes, and/or associated maintenance. Moreover, aspects of this disclosure provide a continuous, low friction surface, e.g., that may be completely free of fasteners or other components on which material can agglomerate.

Aspects of this disclosure also relate to methods for making a multi-material liner. For instance, in some aspects, a first layer having embedded, or otherwise associated magnets can be provided and a second layer having a low-friction surface can be provided. For instance, the first layer can be formed from a urethane that is overmolded onto one or more rare earth magnets. The second layer can be an ultrahigh molecular weight polyethylene, for example. Other materials can also or alternatively be used. In examples, a surface of the first layer and/or a surface of the second layer may be prepared, e.g., by roughening, abrading, or the like, and an adhesive may be applied to either or both of the surfaces. The surfaces may then be brought into contact until the adhesive cures to form a single liner having a surface of the first layer exposed on one side (for coupling to machinery) and a surface of the second layer exposed on an opposite side (for contact by raw material).

Additional techniques for forming a liner also are contemplated herein. For example, in some additional aspects of this disclosure, a low friction layer made of a first material, such as but not limited to ultrahigh molecular weight polyethylene, may be provided. In examples, the layer may be disposed in a mold. One or more magnets, which may be rare earth magnets, may be positioned in the mold relative to the layer. A second material, such as urethane, may be introduced into the mold, e.g., via pouring, injection, and/or some other process. Upon curing of the second material, a multi-layer, magnetic liner is removed from the mold.

The liners according to this disclosure may offer a number of benefits over conventional systems. Without limitation, the devices and techniques described herein may provide improved raw material handling systems, which may be less complex, may be cheaper to manufacture, use, and/or maintain, and/or may have improved outcomes, when compared to similar conventional systems. Moreover, while aspects of this disclosure may be particularly useful in certain application, like conveyor systems, the systems and techniques described herein may be useful with many raw material handling systems where agglomeration can occur.

Aspects of the disclosure will now be explained in more detail with reference to the Figures.

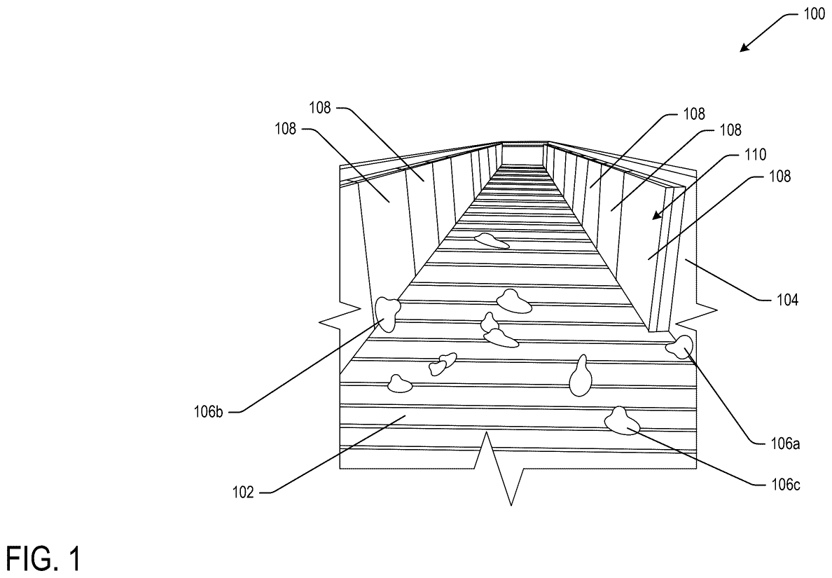

FIG. 1 is a perspective view of aspects of a conveyor assembly 100. The conveyor assembly 100 may be any conventional equipment used to convey, move, retain, hold, or store, or otherwise interact with raw material. In the example, the conveyor assembly 100 is illustrated as including a conveyor belt 102. The conveyor belt 102 may be any moving track, belt, or surface. Although not visible in FIG. 1, the conveyor belt 102 may be driven by one or more actuators that are operably coupled to the conveyor belt 102. For example, and without limitation, the actuators may be coupled to the conveyor belt 102 via one or more drive trains, gears, pulleys, belts, and/or the like.

The conveyor assembly 100 also includes skirting 104. In the illustrated example, the skirting 104 comprises a sidewall disposed over edges of the conveyor belt 102. Although illustrated as a generally vertical sidewall, the skirting 104 may take any number of shapes and configurations, as is generally known in the art. Without limitation, the skirting 104 can be provided adjacent, contacting, above (e.g., as a roof), or otherwise relative to the conveyor belt 102. The skirting 104 may generally be provided to retain raw material on the conveyor belt 102. In some examples, the skirting 104 may be substantially sealed relative to the conveyor belt 102, such that raw material cannot escape the conveyor assembly between the conveyor belt 102 and the skirting 104.

In operation, the conveyor belt 102 is driven to move raw material between locations. For example, and without limitation, the conveyor belt 102 may be configured to transfer raw material from an extraction site to a processing site or the like. The skirting 104 generally is fixed. Thus, the conveyor belt 102 may be driven to move relative to the skirting 104. The conveyor assembly 100, including the conveyor belt 102 and the skirting 104, is illustrated for example only. Other configurations and/or arrangements will be appreciated by those having ordinary skill in the art, and with the benefit of this disclosure.

As shown in FIG. 1, a first instance of raw material 106a, a second instance of raw material 106b, and a third instance of raw material 106c are conveyed by the conveyor belt 102 relative to the skirting 104. Herein, one or more of the instances of the enumerated raw material 106a, 106b, 106c and/or other instances of the raw material may be referred to as “the raw material 106.” As shown, the raw material 106 may be take many shapes, sizes, and forms, and depending on the application, many different formulations. In some examples, the raw material 106 can be extracted from the earth, e.g., from a mine or quarry, and can include a number of different materials. In conventional examples, as the raw material 106 is conveyed, some of the raw material, like the third instance of the raw material 106c contact only the conveyor belt 102. However, other instances of the raw material 106, such as the first instance of the raw material 106a and the second instance of the raw material 106b may be relatively closer to edges of the conveyor belt 102, and thus may come into contact with the skirting 104. As noted above, the skirting 104 may be conventionally provided to maintain the raw material 106 on the conveyor belt. However, in conventional systems, as the first instance of the raw material 106a is moved along the skirting 104, some or all of the first instance of the raw material can stick to the skirting 104. This sticking can lead to buildup on the skirting 104, increased friction and/or wear on the conveyor belt 102, and/or other problems.

Aspects of this disclosure, however, provide one or more liners 108 disposed on the skirting 104. As detailed further herein, the liners 108 provide a low friction surface 110, e.g., compared to the skirting 104, that reduce and/or eliminate build-up of the raw material 106 on the skirting 104. In the illustrated example, and as detailed further herein, the liners 108 may be modular, multi-layer panels that can be coupled to the skirting 104 in a manner that exposes the low friction surface 110 for contact by the raw material 106. Moreover, and as illustrated in FIG. 1, a number of the liners 108 may be arranged, e.g., side-by-side, along a length of the skirting to entirely cover the skirting 104. (Note that a liner 108 is removed proximate the first instance of the raw material 106a to show a portion of the skirting 104 and to provide an example in which the skirting 104 is contacted by the raw material 106, as in conventional systems.)

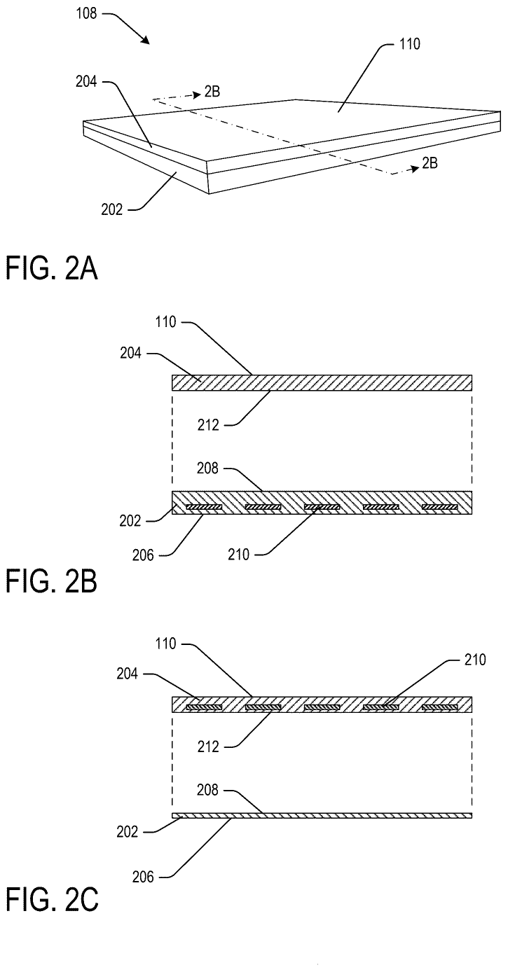

FIGS. 2A-2C show instances of the liners 108 in more detail. More specifically, FIG. 2A is a perspective view of the liner 108, and FIGS. 2B and 2C are exploded, cross-sectional views of example implementations of the liner 108, taken along section line 2B-2B in FIG. 2A. In FIGS. 2A-2C, the same reference numerals introduced in FIG. 1 are used to reference the same components or features.

As shown in FIGS. 2A, 2B, and 2C, the liner 108 generally includes a first layer 202 and a second layer 204 coupled to the first layer 202. In the illustrated example, each of layers 202, 204 has substantially the same outline or footprint. Although the layers 202, 204 are illustrated as being substantially rectangular in shape, other shapes or configurations are contemplated. In examples, however, it may be desirable to align instances of the liners 108 relative to each other (as in the examples of FIG. 1) so the edges and/or ends of the liners 108 may be desirably configured for easy alignment, abutment, or the like. In other examples, the shape and/or size of the liner 108 may be dictated by the equipment with which it is to be used. For example, when intended to be used on skirting that is 11-inches high, the liner 108 may have a corresponding height, whereas when intended for use with skirting that is 16-inches high, the liner 108 may have a 16-inch or 8-inch height to readily cover the skirting.

FIG. 2B shows the two layers 202, 204 in cross-section. As illustrated, the first layer 202 has a thickness generally extending between a first (lower) surface 206 and a second (upper) surface 208. In examples of this disclosure, one or more magnets 210 are associated with the first layer 202. In the illustrated example, the magnets 210 may be embedded in the first layer 202, e.g., disposed between the first surface 206 and the second surface 208 of the first layer 202. In examples, the first layer 202 may form an overmold, e.g., formed via an overmolding process, on the magnets 210.

Although in some examples the first layer 202 may be overmolded on the magnets, in other examples the magnets may be otherwise disposed in the first layer 202. For example, and without limitation, a number of recesses, bores, or the like, e.g., corresponding in number to the magnets 210, may be formed in the second surface 206 and the magnets 210 may be inserted into the recesses/bores. In these examples, the magnets 210 can be retained by an adhesive, a press fit, or other means. In still further examples, a cover may be disposed over one or more of the magnets 210. Moreover, in still further examples, the magnets 210 may not be embedded in the first layer 202. For instance, the magnets 210 can be secured to the first layer 202 in a manner that causes the magnets 210 to protrude from the first surface 206, e.g., away from the second surface 208.

Although a number and arrangement of the magnets 210 are illustrated in FIG. 2B, alternative numbers and/or arrangements may be used. As detailed herein, the magnets 210 are provided to secure the liner 108 to existing machinery, e.g., to the skirting 104 of the conveyor assembly 100 discussed above. Any arrangement or number of magnets 210 that perform this function may be provided. In examples, the magnets 210 may be permanent magnets, such as rare earth magnets. The magnets 210 facilitate ready coupling and removal of the liner 108 to/from the skirting 104 and/or other metallic surfaces. Specifically, unlike some conventional liners, the use of the magnets 210 in the liner 108 obviates the need for mounting holes through which fasteners must be passed. For example, and as shown in the Figures, because no mounting holes are required, the low friction surface 110 is a continuous surface, e.g., free of any components that could provide a surface at which raw material could accumulate.

The example of FIG. 2C shows the magnets 210 disposed in the second layer 204, instead of the in the first layer 202. In this example, the first layer 202 may be relatively thinner, e.g., because the magnets are effectively securing the liner 108 to the equipment surface “through” the first layer 202. In this example, the first, relatively higher friction layer 202 is still provided in contact with the equipment surface and the second, relatively lower friction layer 204 is still provided to interface with the raw material. In other examples, one or more of the magnets 210 may be provided in either or both of the first layer 202 and the second layer 204. In still further examples, individual of the magnets 210 may be disposed at least partially in the first layer 202 and/or at least partially in the second layer 204.

As shown in both FIGS. 2B and 2C, the second layer 204 includes the low friction surface 110 (e.g., as a top surface) and an opposite, second (lower) surface 212. The low friction surface 110 and the second surface 212 are generally parallel, planar surfaces that are separated by a thickness of the second layer 204. Although illustrated as planar, one or both of the surfaces 110, 212 may be contoured or otherwise formed.

The second surface 212 of the second layer 204 generally faces the second surface 208 of the first layer 202. In examples, the first layer 202 is fixed to the second layer 204 at an interface of the second surface 212 of the second layer 204 and the second surface 208 of the first layer 202 to form the liner 108. In some examples, an adhesive, epoxy, or the like, can be applied at the interface to fix or bond the first layer 202 and the second layer 204 to form the liner 108. Also in examples, the second surface 208 of the first layer 202 and/or the second surface 212 of the second layer 204 may be treated to facilitate such adhering or bonding. Without limitation, either or both of the second surfaces 208, 212 may be chemically, mechanically, or otherwise treated to enhance the surface(s) for bonding. In some examples the surface(s) may be roughened such as by abrasive blasting, sand blasting, wire brushing, abrading, or the like.

In other examples, as described further herein, the liner 108 may be formed by bonding one of the first layer 202 or the second layer 204 onto the other layer. For instance, in at least one example, the second layer 204 including the low friction surface 110 may be positioned in a mold and the first layer 202 may be molded onto the second layer 204. These and additional methods of manufacture are described further herein.

Regardless of the method of manufacture, examples of the liner 108 according to this disclosure generally comprise a laminated structure having a first layer of a first material and a second layer of a second material. At least one of the layers, e.g., the first layer 202 in FIG. 2B or the second layer 204 in the example of FIG. 2C, includes the magnets 210 for selectively attaching the first layer 202 to existing equipment. The second material is selected to have a lower coefficient of friction than the first material, e.g., such that the low friction surface 110 that is exposed to contact with the raw material resists accumulation of the raw material thereon.

The first material is chosen to have a higher coefficient of friction, e.g., such that the liner 108 resists movement during use. As will be appreciated, as raw material contacts and passes along the liner 108, the liner may experience forces that create shear at an interface between the liner 108 and the equipment (e.g., the conveyor assembly 100). Because of its higher coefficient of friction, the first material may be better suited to resist movement that could otherwise occur under these forces. For example, the inventors have found that while certain low friction materials (like UHMW) are effective for reducing accumulation of raw materials, as described herein, making a liner solely of such materials may be undesirable. In one example experiment, the inventors applied forces to two example liners, one liner having the two-layer structure of FIG. 2A, with the relatively higher friction surface contacting a metallic test surface, and a second corresponding to a liner in which only the low friction material is used and contacts the metallic test surface. Test forces were applied in a direction normal to a direction of a magnetic force between the example liner and a metallic test surface, e.g., to mimic the shear force described above. As a result of the experiment, the inventors found that the applied forces required to move the first example liner relative to the metallic test surface were between about 85% and 90% higher than those required to move the second example liner. Thus, in examples of this disclosure, the first layer aids in maintaining the liner 108 in place, whereas the second layer provides the low friction surface 110 that resists accumulation.

The first material may be a polymeric material, such as a urethane. In examples, the first material may be chosen for its compatibility with an overmolding process used to embed the magnets 210 therein. The first material may also be chosen for its relative stiffness, e.g., to ensure that the liner 108 is structurally rigid. Although urethane is one example, other polymeric materials may be used.

The second material may be a different polymeric material having a lower coefficient of friction than the first material. For example, and without limitation, the second material may be Teflon, nylon (e.g., with or without additives), or an ultra-high molecular weight polymer. In examples, the polymer may be chosen for its low coefficient of friction. In some non-limiting examples, the second material may have a coefficient of friction of less than 0.2, whereas the first material may have a coefficient of friction of greater than 0.2. The second material can also be selected to have a relatively high lubriciousness, a high electrostatic dissipation, and/or other properties that will inhibit or resist material accumulation.

In addition to having different material properties, the first material and/or the second material may have a low surface energy. Materials with low surface energy may be difficult to bond. Moreover, some low coefficient of friction materials, like UHMW may be prone to sagging and/or creep under tensile loads. Moreover, the different materials may react differently to temperature changes. For these and other reasons, securing the first layer 202 to the second layer 204 may be difficult. In some examples, the second surface 208 of the first layer 202 and the second surface 212 of the second layer 204 may bonded using an adhesive or epoxy. The adhesive may be a thixotropic adhesive. As noted above, in examples, one or both of the second surface 208 of the first layer 202 and/or the second surface 212 of the second layer 204 may be treated prior to adhesion.

As will be appreciated, once the first layer 202 and the second layer are bonded or otherwise fixed, the liner 108 is ready for use. In practice, the first surface 206 of the first layer is retained on a surface of the equipment with which the liner 108 is to be used, e.g., on the skirting 104. The magnets 210 facilitate this retention. So retained, the low friction surface 110 is exposed to raw material, such as the raw material 106 on the conveyor assembly 100, discussed above.

As will be appreciated, the magnets 210 facilitate easy attachment and removal of the liner 108, e.g., compared to conventional mechanical fasteners such as bolts or the like. Thus, the liner 108 can be readily positioned at any number of different places and/or at any number of configurations. Moreover, should the liner 108 become damaged, worn, or otherwise in need of replacement, a technician can readily replace the liner 108 without the need for costly downtime and maintenance.

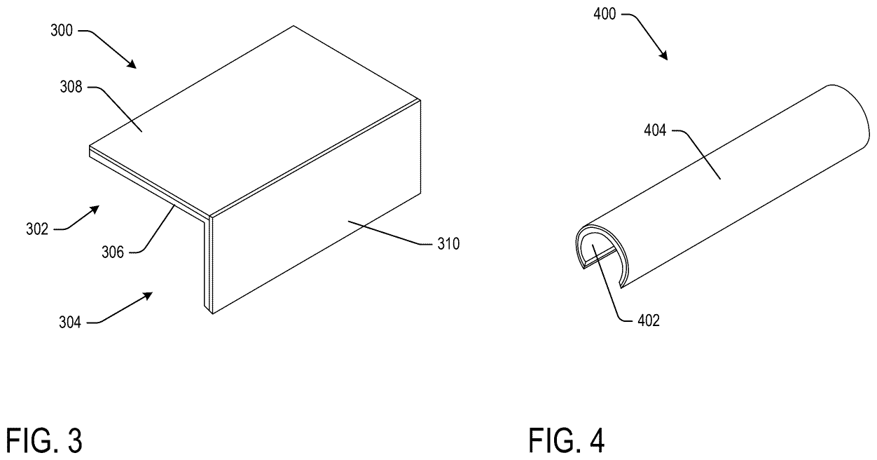

Although the liner 108 is illustrated as a substantially planar liner, other shapes and configurations also are contemplated. For example, FIGS. 3 and 4 show additional configurations according to additional examples. More specifically, FIG. 3 shows an example of an angled liner 300, and FIG. 4 shows an example of an arcuate liner 400.

The angled liner 300 of FIG. 3 generally includes a first leg 302 and a second leg 304 arranged substantially perpendicularly to the first leg 302. Although the legs 302, 304 are illustrated as being arranged at a right angle, in other examples the legs 302, 304 may be arranged at some different angle. Without limitation, the angle between the legs 302, 304 may be determined based on a configuration of the equipment with which the angled liner 300 is to be used.

Like the liner 108, the angled liner 300 generally includes a first layer 306 configured for abutment to an equipment surface. Although not visible in FIG. 3, the first layer 306 may have one or more associated magnets, like the magnets 210 discussed above. In examples, the magnets may be associated with either or both of the legs 302, 304.

The angled liner 300 also includes a second layer comprising a low friction layer, e.g., having a lower coefficient of friction than the first layer 306. In the illustrated example, the second layer comprises a first low friction surface 308 associated with the first leg 302 and a second low friction surface 310 associated with the second leg 302. In examples, the first low friction surface 308 may be formed of a first sheet of a low friction material and the second low friction surface 310 may be formed of a second sheet of the low friction material. Without limitation, the first layer 306 may be a molded layer that is molded in the illustrated L-shape, and the sheets of low friction material can be fixed, e.g., individually adhered, to the legs of the first layer 306. Although the angled liner 300 is illustrated as including the first low friction surface 308 on the first leg 302 and the second low friction surface 310 on the second leg, in other examples one of the first low friction surface 308 or the second low friction surface 310 may be altered or eliminated. Without limitation, the first leg 302 or the second leg 304 may be at least partially exposed. Such an arrangement may be particularly useful when at least a portion of the one of the legs 302, 304 is unlikely to come into contact with material, for instance.

Also like the previously-described liners 108, 300 the arcuate liner 400 generally includes a first layer 402 configured for abutment to an equipment surface. Although not visible in FIG. 4, the first layer 402 may have one or more associated magnets, like the magnets 210 discussed above. In other examples, however, the magnets may be omitted, e.g., because the arcuate liner 400 may perform as a sleeve, and may be less likely to move relative to equipment on which it is mounted.

In the example of FIG. 4, the first layer has an arcuate profile, e.g., generally formed about a radius. The arcuate liner 400 also includes a second layer 404 comprising a low friction layer, e.g., having a lower coefficient of friction than the first layer 402. In examples, the first layer 402 may be a molded layer that is molded in the illustrated C-shape, and the second layer 404 may comprise a sheet of low friction material that is bent onto and/or fixed to an outer surface of the first layer 402. In other examples, the first layer 402 and the second layer 404 may be generally planar members bonded to each other, e.g., as in the liner 108 discussed above, and the arcuate liner 400 may be formed via a subsequent bending step.

The liners 300, 400 are but examples of two different multi-layer liners that can be formed according to teachings of this disclosure. Other shapes, configurations and/or sizes also are contemplated and may be formed. Without limitation, aspects of this disclosure may be used to provide a low-friction liner for any surface(s) associated with conventional material handling equipment.

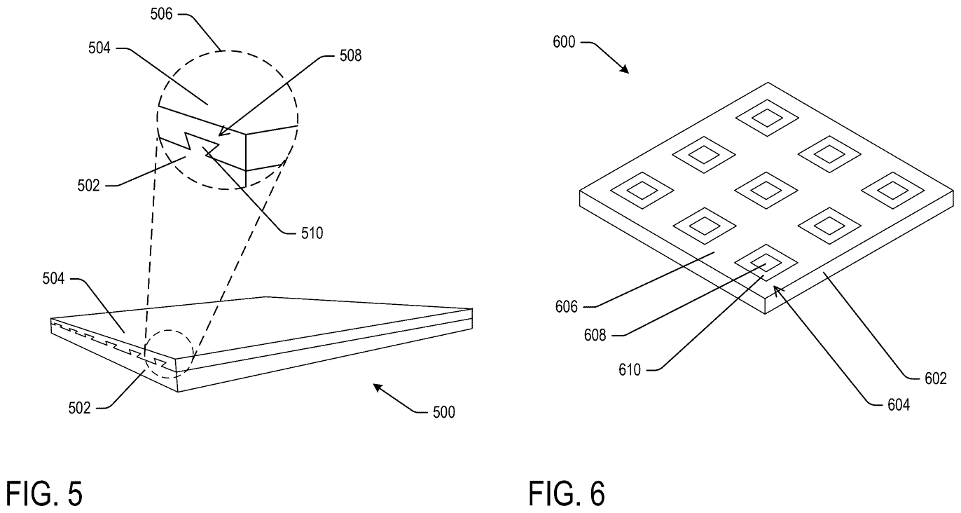

Examples of the liners just described and shown in FIGS. 2A, 2B, 2C, 3, and 4, two different layers, having different coefficients of friction and/or other properties, may be coupled to each other using adhesives, epoxies, or the like, such as by lamination. In some examples, however, these liners may be prone to failure at the joined surfaces, e.g., by delamination. FIG. 5 shows an alternative example in which a liner 500 includes features to promote mechanical coupling of two layers.

More specifically, as shown in FIG. 5, the liner 500 includes a first layer 502 configured for abutment to an equipment surface. Although not visible in FIG. 5, the first layer 502 may have one or more associated magnets, like the magnets 210 discussed above. In examples, the magnets may be embedded in the first layer 502. The liner 500 also includes a second layer 504 comprising a low friction layer, e.g., having a lower coefficient of friction than the first layer 502. The second layer 504 may correspond in composition to one of the layers described previously herein.

FIG. 5 also includes a magnified section 506 showing additional aspects of an interface between the first layer 502 and the second layer 504. More specifically, the magnified section 506, shows that the second layer 504 has a number of grooves 508 configured to receive protrusions 510 of the first layer 502. In the illustrated example, the grooves 508 are formed longitudinally in a surface of the second layer 504, e.g., in the surface facing the first layer 502. In the illustrated example, each of the grooves 508 comprises an undercut profile, e.g., in which a width of the groove at the surface of the second layer 504 is narrower than at a distance from the surface. The protrusions 510 have a corresponding profile, e.g., in which the protrusions are wider at distances from the surface of the first layer 502 on which the protrusions are formed. As will be appreciated, this arrangement may form a locking engagement between the first layer 502 and the second layer 504 that resists movement of the first layer 502 relatively away from the second layer 504, e.g., as in delamination. The number, cross-sectional configuration, and/or other features of the grooves 508 and/or the protrusions 510 are for example only. For example, more or fewer instances of the grooves 508 and/or protrusions 510 may be provided and/or different configurations that facilitate coupling of the layers 502, 504 also are contemplated and will be appreciated by those having ordinary skill in the art, with the benefit of this disclosure.

In examples, the liner 500 may be formed by molding the first layer 502 on to the second layer 504. In one non-limiting example, the second layer 504 may be formed by milling or otherwise forming the grooves 508 in a surface of a sheet or block comprising the second layer, such as a UHMW sheet or block. A polymeric material may be poured or otherwise introduced on the second layer 504, e.g., according to a molding process. The polymeric material is caused to enter the grooves 508. The protrusions 510 (and the first layer 502) are formed as the polymeric material cures or hardens. As noted above, the profile of the grooves 508 may be selected to facilitate retention of the cured polymer, e.g., as the first layer 502. Accordingly, the use of an adhesive, epoxy, or the like may not be required, as in previous examples. However, the second layer 504 and/or surfaces of the grooves 506 may be treated with an epoxy, adhesive, and/or other bonding agent.

FIG. 6 shows yet another example of a liner 600 for use with a material handling system. The liner 600 includes only a single layer 602 of material, unlike previous examples described herein. For example, the single layer 602 may have a composition that corresponds to the second, low friction layers 204, 308, 310, 404, 504 described herein. In the example of FIG. 6, a plurality of recesses 604 are formed in a first surface 606 of the layer 602. The recesses 604 may be bores or pockets formed in the layer 602, e.g., that extend a depth into, but not all the way through, the layer 602. The array of recesses 604 shown in FIG. 6 is for example only; other examples may have more, fewer, and/or differently arranged instances of the recesses 604. Without limitation, the recesses 604 may be formed via molding, milling, drilling, and/or other processes.

Magnets 608 are disposed in the recesses 604. The magnets 608 may correspond to the magnets 210 discussed above, for example. For example, and without limitation, the magnets 210 may be rare earth magnets. Although shown as generally rectangular, the magnets 210 may be of any shape, size and/or configuration that may be received in the recesses 604. As also shown in FIG. 6, the magnets 608 are retained in the recesses 604 using an adhesive 610. The adhesive 610 may be a bonding agent, epoxy, or any other material that can be used to retain the magnets 608 in the recesses 604.

In use, the liner 600 is applied to a surface by abutting the surface 606 to a surface of a material handling system. A surface of the liner 600 opposite the surface 606, e.g., the surface parallel to the surface 606 and obscured in the example of FIG. 6, will thus provide a low friction surface that is positioned for contacting by raw material, like the low friction surface 110 described above.

Modifications to the liner 600 also are contemplated. For instance, in one other non-limiting examples, the recesses 604 and the magnets 608 may be sized to provide an interference fit. In these examples the adhesive 610 may be optional. However, when the adhesive 610 is not used, the retention force between the magnets 608 and the recesses 604 should be sufficiently strong that removal of the liner 600 from a metallic surface does not result in dislodging of the magnets 608.

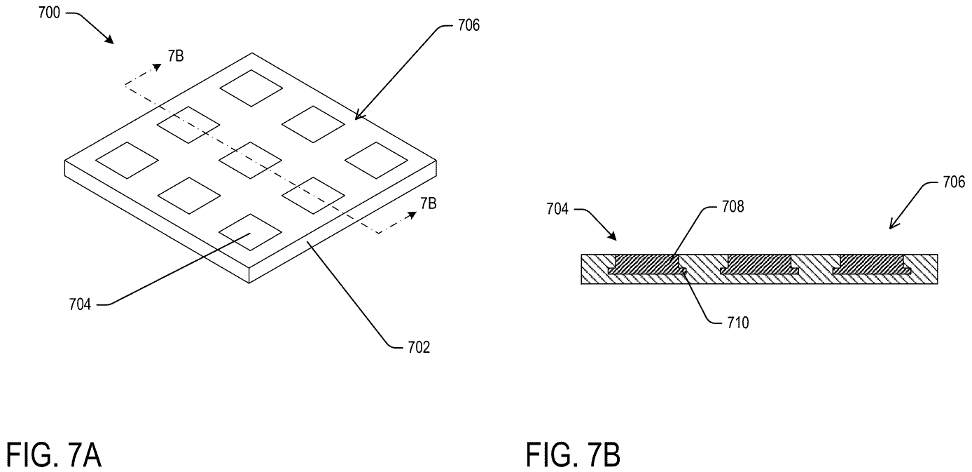

FIGS. 7A and 7B show yet another alternative example of a liner 700 according to examples of this disclosure. As shown in FIGS. 7A and 7B, the liner 700 includes a layer 702 of a material that is configured for abutment to an equipment surface. Although not illustrated in FIG. 7, the first layer 502 may have one or more associated magnets, like the magnets 210 discussed above. In examples, the magnets may be embedded in the layer 702.

The liner 700 also includes a number of inserts 704 disposed in the layer 702. The inserts 704 are low friction inserts, e.g., having a lower coefficient of friction than the layer 702. For example, the inserts 704 may correspond in composition to one of the low friction layers described previously herein.

In the example of FIG. 7A, the inserts 704 are arranged in an array within the layer 702 such that an upper surface 706 of the liner 700 comprises exposed surfaces of the inserts 704 spaced by portions of the layer 702. In use, the liner 700 is positioned such that the upper surface 706 is exposed to raw materials, as described herein. The number, arrangement, and spacing of the inserts 704 is for example only-more or fewer inserts 704 arranged in other configurations also are contemplated. For example, using more and/or larger inserts 704 may imbue the upper surface 706 with more “low friction” surface area, whereas fewer and/or smaller inserts 704 may result in less of this low friction surface area.

As illustrated in FIG. 7B, the inserts 704 may have a stepped profile that includes a body 708 and a flange 710 extending laterally from the body 708. In examples, the flange 710 provides a larger footprint that facilitates retention of the insert 704 in the layer. The flange 710 is illustrated as extending laterally from opposing sides of the body 708. In examples, the flange 710 can extend from any or all surfaces or sides of the body 708. Moreover, although the body 708 is illustrated as being formed substantially as a rectangular prism, other shapes and/or configurations are contemplated.

In examples, the liner 700 may be formed by molding the layer 702 onto the inserts 704. In one non-limiting example, the inserts 704 may be formed from one or more blocks and/or sheet(s) of a low friction material, such as UHMW block(s) and/or sheet(s). The inserts 704 may then be arranged in a mold, and a polymeric material may be poured or otherwise introduced on and between the inserts 704, e.g., according to a molding process. The polymeric material is caused to fill voids between the inserts to contacts sides of the inserts 704 and encapsulate the flanges 710. The layer 702 is formed as the polymeric material cures or hardens. As noted above, the flanges 710 may be provided to facilitate retention of the cured polymer, e.g., as the layer 702. Accordingly, the use of an adhesive, epoxy, or the like may not be required in the example of FIGS. 7A and 7B. However, the inserts 704 may be treated with an epoxy, adhesive, and/or other bonding agent.

Although the example of FIGS. 7A and 7B contemplates including the flanges 710 on the inserts 704, some modifications may not require the flanges 710 or the flanges 710 may be differently formed. In one alternative example, one or more surfaces of the inserts 704 may instead be provided with grooves, like the grooves 508 discussed above. In still further examples, sides of the inserts 704 may be angled. For example, one or more sides of the body 708 may be formed at an angle larger than 90-degrees relative to the exposed surface of the insert 702. Thus, at the exposed surface 706, the exposed area of the insert 702 is smaller than at locations spaced from the exposed area. Stated, differently, the insert 702 can take many shapes and configurations in which a footprint of the insert 702 is larger than the exposed area of the insert 702. As will be appreciated, such arrangement may form a locking engagement between the layer 702 and the inserts 704 that resists movement of the first layer 502 relatively away from the second layer 504, e.g., as in delamination.

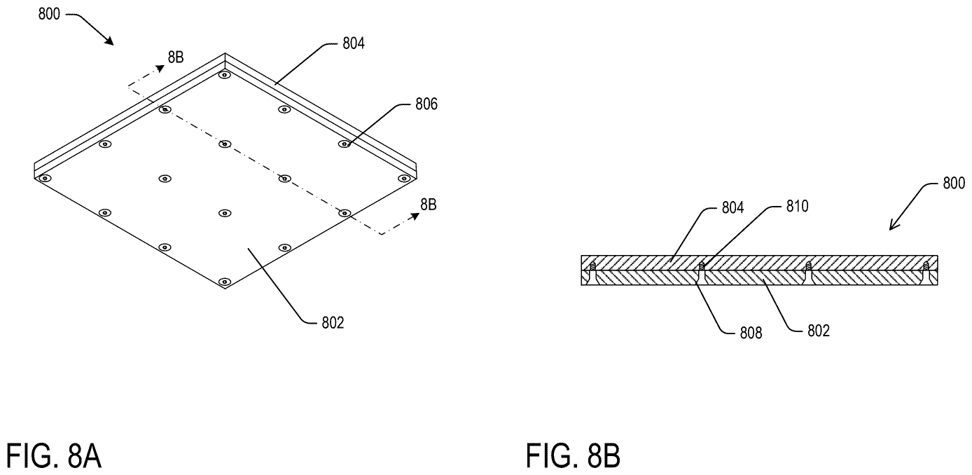

FIGS. 8A and 8B show yet another alternative example of a liner 800 according to examples of this disclosure. As shown in FIGS. 8A and 8B, the liner 800 includes a first layer 802 configured for abutment to an equipment surface. Although not visible in FIGS. 8A and 8B, the first layer 802 may have one or more associated magnets, like the magnets 210 discussed above. In examples, the magnets may be embedded in the first layer 802. The liner 800 also includes a second layer 804 comprising a low friction layer, e.g., having a lower coefficient of friction than the first layer 802. The second layer 804 may correspond in composition to one of the low friction layers described previously herein.

FIG. 8A also shows a number of threaded fasteners 806. The threaded fasteners 806 are configured to secure the first layer 802 to the second layer 804. In the example of FIG. 8A, the threaded fasteners 806 include sixteen fasteners arranged in a four-by-four array. The number, arrangement, and type of fasteners shown in FIG. 8A are for example only. Any arrangement or number of fasteners that can secure layers 802, 804 to each other may be used.

FIG. 8B shows the threaded engagement in more detail. FIG. 8B is a cross-sectional view of the liner 800 taken along the section line 8B-8B in FIG. 8A. As illustrated, a number of through holes 808 are formed through the first layer 802, and the second layer 804 includes corresponding (in position and number) threaded bores 810. As will be appreciated, and although not shown in FIG. 8B, the fasteners 806 pass through the holes 808 in the first layer 802 and are threaded into the threaded bores 810 in the second layer 804 to secure the first layer 802 to the second layer 804 to form the liner 800. In the illustrated example, the threaded bores 810 are illustrated as being formed directly in the second layer 804. In other examples, however, the threaded bores 810 may comprise threaded inserts that are pressed or otherwise secured in bores or holes formed in the second layer 804. Moreover, although the threaded bores 810 are shown as bores, e.g., extending less than all the way through the thickness of the second layer 804, in other examples the threaded bores 810 may extend all the way through the second layer 804. In examples, plugs or the like may be placed in the holes to form the threaded bores 810.

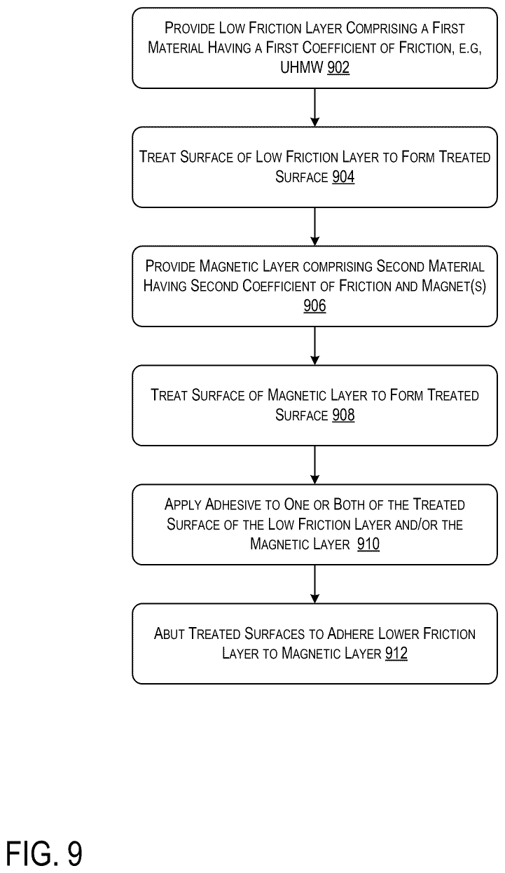

FIG. 9 shows a process 900 for manufacturing a liner. More specifically, FIG. 9 includes a flowchart showing a number of operations associated with the process 900. In examples, the process 900 can be used to manufacture the liner 108, the angled liner 300, and/or the arcuate liner 400, however, the process 900 is not limited to manufacturing the liners 108, 300, 400, and the liners 108, 300, 400 need not be manufactured using the process 900.

At an operation 902, the process 900 includes providing a low friction layer comprising a first material having a first coefficient of friction. In examples, the low friction layer may be the second layer 204 in FIG. 2. For example, the low friction layer may be a UHMW sheet.

At an operation 904, the process 900 includes treating a surface of the low friction layer to form a treated surface. In examples, the operation 904 can including abrading, roughening, or otherwise increasing a surface area of a surface of the low friction layer. In examples, the operation 904 can be performed manually, e.g., using sandpaper or the like. In other examples, the operation 904 can be at least partially automated, e.g., using blasting equipment or the like. The operation 904 may be performed to ready the surface for fixing to a second layer of material. The operation 904 may also, or alternatively, include one or more chemical treatments. For example, the operation 904 can include flame etching.

At an operation 906, the process 900 includes providing a magnetic layer comprising a second material having a second coefficient of friction and one or more magnets. The operation 906 can include providing the first layer 202 including the magnets 210, discussed above.

At an operation 908, the process 900 includes treating a surface of the magnetic layer to form a treated surface. In examples, the operation 908 can including abrading, roughening, or otherwise increasing a surface area of a surface of the low friction layer. In examples, the operation 908 can be performed manually, e.g., using sandpaper or the like. In other examples, the operation 908 can be at least partially automated, e.g., using blasting equipment or the like. The operation 908 may be performed to ready the surface for fixing to the low friction layer of material. Although the process 900 includes both the operation 904 and the operation 908, in other examples, only one surface may be treated, such that the process 900 may only include the operation 904 or the operation 908.

At an operation 910, the process 900 includes applying an adhesive to one or both of the treated surfaces. For example, the adhesive may be a thixotropic epoxy that is applied to the treated surface(s) of the low friction layer and/or the magnetic layer. As detailed herein, the adhesive may be selected to bond the disparate materials forming the two layers.

At an operation 912, the process 900 includes abutting the treated surfaces to adhere the low friction layer to the magnetic layer. In examples, the operation 912 can also include clamping or otherwise retaining the layers until a time at which the adhesive cures. Once cured, a multi-layer liner with a low coefficient of friction surface is complete. The liner may be magnetically coupled to equipment to provide a contact surface on which raw material is unlikely to agglomerate. Moreover, because the multi-layer liner is free of mechanical fasteners on the low friction surface, the liner is substantially free of any surfaces that would accumulate raw material.

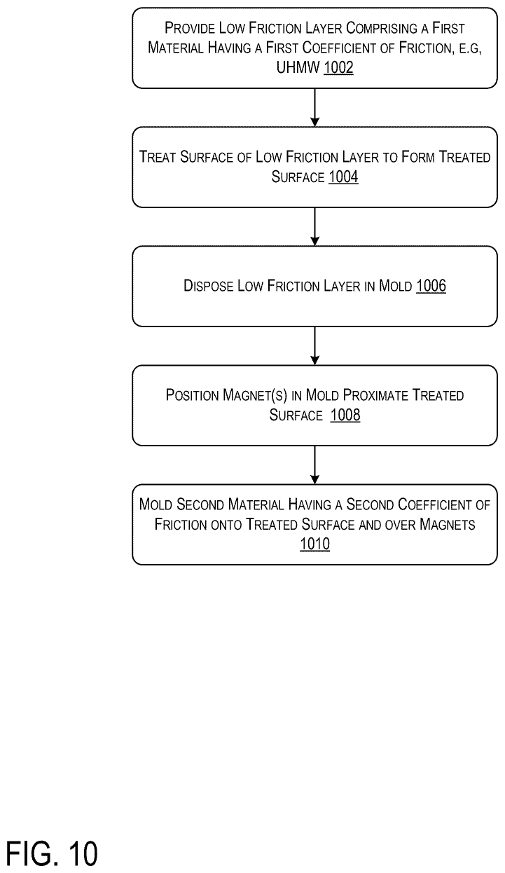

FIG. 10 shows a process 1000 according to another example of this disclosure for manufacturing a liner. More specifically, FIG. 10 includes a flowchart showing a number of operations associated with the process 1000. In examples, the process 1000 can be used to manufacture the liner 108, the angled liner 300, and/or the arcuate liner 400, however, the process 1000 is not limited to manufacturing the liners 108, 300, 400, and the liners 108, 300, 400 need not be manufactured using the process 1000.

At an operation 1002, the process 1000 includes providing a low friction layer comprising a first material having a first coefficient of friction. In examples, the low friction layer may be the second layer 204 in FIG. 2. For example, the low friction layer may be a UHMW sheet. The operation 1002 may be substantially the same as the operation 502.

At an operation 1004, the process 1000 includes treating a surface of the low friction layer to form a treated surface. In examples, the operation 1004 may be substantially the same as the operation 504. In other examples, the operation 1004 can also or alternatively include treating the surface by applying an adhesive, epoxy, or other material to the surface. For instance, the

At an operation 1006, the process 1000 includes disposing the low friction layer in a mold. In examples, the low friction layer may be a sheet that is placed horizontally in a mold with the treated surface formed at the operation 1004 facing upward or otherwise exposed.

At an operation 1008, the process 1000 includes positioning one or more magnets in the mold proximate the treated surface. For example, magnets, like the magnets 210, may be positioned in an array relative to the treated surface in the mold. The magnets may be placed directly on the treated surface or spaced from the treated surface. Without limitation, the magnets may be rare earth magnets.

At an operation 1010, the process 1000 includes molding a second material having a second coefficient of friction onto the treated surface and over the magnets. For example, the second material may be a polymeric material having a higher coefficient of friction than the material comprising the low friction layer. For example, the material may be a urethane. As will be appreciated, the operation 1010 forms a layer in which the magnets are disposed, e.g., corresponding to the first layer 202 discussed above. Once molded, the process 1000 has created a multi-layer liner with a low coefficient of friction surface. The liner may be magnetically coupled to equipment to provide a contact surface on which raw material is unlikely to agglomerate. Moreover, because the multi-layer liner is free of mechanical fasteners on the low friction surface, the liner is substantially free of any surfaces that would accumulate raw material.

Modifications to the process 1000 also are contemplated. For example, the operation 1008 may be omitted or altered. Without limitation, the operation 1010 may be carried out in the absence of the magnets, such that the second material is molded onto the low friction layer to form a multi-layer liner without magnets. The magnets may be subsequently coupled to the second material, e.g., on a surface opposite the exposed surface of the low friction layer.

In another alternative to the process 1000, the operations 1008 and 1010 may be undertaken prior to joining the low friction layer. For instance, the magnets may be placed in a mold (according to the operation 1008) and the second material may be introduced to the mold (according to the operation 1010), e.g., to cover the magnets. The low friction layer may then be placed in the mold (according to the operation 1006) with the treated surface being placed on the second material in the mold. The low friction layer can be placed on the second material before, during, or after curing the of the second material, for example.

In a still further change, a process according to this disclosure may include forming a liner as a single layer with embedded magnets. For example, the entire liner may be formed from the low coefficient of friction material described herein. Such a process may include positioning one or more magnets in a mold. For example, magnets, like the magnets 210, may be positioned in an array in the mold. Without limitation, the magnets may be rare earth magnets.

At a subsequent operation, the alternative process includes molding a material having a low coefficient of friction over the magnets. For example, the material may be a polymeric material having a low coefficient of friction such as used in the low friction layers described herein. For example, the material may be a UHWM. The process of molding the material can include injection molding or some other thermoplastic processing method. As will be appreciated, this alternative process forms a single, low friction layer in which the magnets are disposed.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A liner for material handling equipment, the liner comprising:
a first layer comprising a first material having a first coefficient of friction, the first layer including a first surface and a second surface opposite the first surface;
a second layer comprising a second material having a second coefficient of friction lower than the first coefficient of friction, the second layer having a third surface and a fourth surface opposite the third surface, wherein the second layer is coupled to the first layer such that the third surface of the second layer is fixed to the second surface of the first layer; and
one or more magnets configured to cooperate with a metallic surface of the material handling equipment to retain the first surface of the first layer proximate the metallic surface.

2. The liner of claim 1, wherein the one or more magnets are embedded in the first layer.

3. The liner of claim 1, wherein the first layer is overmolded on the one or more magnets.

4. The liner of claim 1, wherein the fourth surface is continuous and substantially planar.

5. The liner of claim 1, wherein the first material comprises urethane.

6. The liner of claim 1, wherein the second material comprises a polymer.

7. The liner of claim 6, wherein the polymer comprises at least one of a polytetrafluoroethylene, a fluoropolymer, a nylon, or an ultrahigh molecular weight polyethylene.

8. The liner of claim 1, further comprising an adhesive fixing the second surface of the first layer to the third surface of the second layer.

9. The liner of claim 8, wherein the adhesive is a thixotropic adhesive.

10. The liner of claim 1, wherein the second layer is molded onto the second surface of the first layer.

11. A conveyor assembly comprising:
a movable conveyor belt disposed to carry raw material;
a stationary wall proximate the conveyor belt; and
a liner coupled to the stationary wall to at least partially cover the stationary wall, the liner comprising:
a first polymeric layer comprising a first material having a first coefficient of friction, the first polymeric layer including a first surface and a second surface opposite the first surface;
a second polymeric layer comprising a second material having a second coefficient of friction lower than the first coefficient of friction, the second polymeric layer being disposed on the second surface of the first polymeric layer; and
one or more magnets configured to cooperate with the stationary wall to retain the first surface of the first layer on the stationary wall.

12. The conveyor assembly of claim 11, wherein the second polymeric layer comprises at least one of a polytetrafluoroethylene, a fluoropolymer, a nylon, or an ultrahigh molecular weight polyethylene.

13. The conveyor assembly of claim 11, wherein the second polymeric layer defines an outer surface disposed to be contacted by raw material on the conveyor belt.

14. The conveyor assembly of claim 13, wherein the liner is free of holes.

15. The conveyor assembly of claim 11, wherein the one or more magnets are embedded in the first polymeric layer.

16. A method of making a liner for use in a conveyor assembly, the method comprising:
providing a first layer comprising a first material and having a first coefficient of friction;
treating a surface of the first layer to form a treated surface; and
disposing a second layer comprising a second material and one or more magnets on the treated surface, the second material having a second coefficient of friction higher than the first coefficient of friction.

17. The method of claim 16, wherein the treating the first layer comprises increasing a surface area of the treated surface by roughening the treated surface.

18. The method of claim 16, wherein the treating the first layer comprises applying an adhesive to the treated surface.

19. The method of claim 16, wherein the disposing the second layer on the treated surface comprises adhering the second layer on the treated surface.

20. The method of claim 16, wherein the disposing the second layer on the treated surface comprises molding the second layer directly on the treated surface.
